(19) United States
(12) Patent Application Publication
(10) Pub. No.: US 2026/0181317 A1
(43) Pub. Date: Jun. 25, 2026

(54) HEARABLE DEVICE FOCUS ON A MOVING SOUND SOURCE

(71) Applicant: Sony Group Corporation, Tokyo (JP)

(72) Inventors: Brant L. Candelore, Poway, CA (US); James R Milne, San Diego, CA (US); Justin Kenefick, San Diego, CA (US); William Clay, San Diego, CA (US)

(73) Assignee: Sony Group Corporation, Tokyo (JP)

(21) Appl. No.: 19/001,107

(22) Filed: Dec. 24, 2024

(51) Int. Cl. H04R 1/40; H04R 1/10; H04R 25/00

(52) U.S. Cl. CPC H04R 1/406; H04R 1/10; H04R 25/405; H04R 25/507; H04R 2430/20

(57) ABSTRACT

An auditory scanning system is provided to enable a hearable device to focus on a sound as the sound source changes locations relative to a user of the hearable device. The system scans the environment to detect when a source of a sound changes physical locations in an environment and estimate a general location of the sound source relative to the user. Certain microphones associated with the hearable device carry out specific functions which can seamlessly track the sound source as it moves around the environment. Primary microphones can maintain focus on an area in a known sound source direction while scanning microphones may search the environment for the sound source changing locations. Listening parameters, such as those used in beamforming, may be automatically adjusted to refocus the hearable device in a direction of the changed location and/or a predicted impending change of location.

### BACKGROUND

Hearable devices (also called “hearables” or “auditory devices”) can help a user hear particular sounds in the environment by employing multiple microphones. Various types of hearable devices are ear worn and/or implantable to alter the hearing of the user, such as headphones, earbuds, hearing aids, in-ear devices, e.g., cochlear implants. Combination hearable devices can perform multiple hearing functions, such as headphones or earbuds performing clinical grade hearing aid functionalities, etc. Microphones used in various hearable devices can include omnidirectional and directional microphones.

Directional microphones can increase signal to noise ratio (SNR), by improving the hearing of a particular sound and decreasing extraneous sound listening. Beamform techniques can steer the focus of a hearable device toward a direction of a target sound. Often times while the user is listening to a sound, the source changes locations. Such moving sound sources can present challenges for the hearable device to maintain a fix on the sound.

### SUMMARY

An auditory scanning system (also called “scanning system” or “system”) is provided with components including a hearable device, which perform a scanning process to detect when a source of a sound changes physical locations in an environment and estimate a general location of the sound source relative to the user. Listening parameters, such as those used in beamforming, may be automatically adjusted to refocus the hearable device in a direction of the changed location and/or a predicted change of location.

An auditory scanning method is provided that is implemented by one or more computers in which a hearable device adjusts focus sensitivity on a sound source that moves in an environment. During a first time period, primary microphones of the hearable device capture first sound waves from the sound source in a first location of the environment. Capture is performed by using a primary audio beam formed to focus on a first direction relative to the user. While the focus on the first direction is maintained by the primary microphones, scanning microphones are used to scan the environment by forming a scanning audio beam displaced from the first direction to capture second sound waves that indicate a first changed location of the sound source relative to the user during a second time period. The primary audio beam is formed to focus on a second direction of the first changed location. The first changed location may include a change in a horizontal direction, a vertical direction, a forward direction and/or a backward direction relative to the user.

In some aspects of the method, scanning microphones may scan the environment iteratively by repeatedly forming the scanning audio beam at incremental direction angles from a prior scanning direction or from the first direction. The scanning iterations may stop when the at least one additional changed location is detected and/or continue to repeat for next changed locations. In some cases, the scanning of the environment may be performed according to a predefined schedule when the hearable device is in a scanning mode.

The method can also include detecting first identifying sound characteristics of the first sound waves from the first direction, as well as second sound characteristics of the second sound waves from the second direction. The second sound characteristics can be matched with the first sound characteristics to confirm that the second sound waves are from the sound source.

In some implementations, the method may include determining movement features associated with the sound source relocating from the first changed location to the at least one additional changed location. An artificial intelligence (AI) model may be employed to make movement predictions about the sound source. The AI model may be trained on known movement features, prior location changes, and sound source information. Inputs for the AI model may include movement features and sound source identifying information. The resulting outputs of the AI model may include a predicted changed location of the sound source for a predicted time. Based at least in part, on the predicted changed location, the primary audio beam may be formed in a third direction during the predicted time.

In some cases, expanding and contracting beam dimensions may be used to scan and/or focus onto a location. For example, the primary audio beam may be formed in the second direction to include a changed location of the sound source by expanding a width of the primary audio beam to cover a scanning area of the scanning audio beam in the second direction.

In still some implementations, scanning of the environment may include repeatedly expanding a width of the scanning audio beam from an original width consistent with the width and direction of the primary audio beam, to cover a scanning focus area. The scanning audio beam may then return to the original width and direction if the second sound waves are undetected.

The process can also include analyzing the second sound waves to detect a degradation pattern between scanning microphones of a first hearing unit at a first user ear and a second hearing unit at a second user ear to determine the second direction.

In some implementations, an auditory scanning system is provided, which includes a hearable device that has primary microphones and scanning microphones. The hearable device includes one or more processors and logic encoded in one or more non-transitory media for execution by the one or more processors. When the logic is executed, the logic is operable to perform various operations as described above in terms of the method. The operations include at least some of the methods described above and below.

In some implementations, a non-transitory computer-readable storage medium is provided which carries program instructions for adjusting a hearable device of a user to focus on a sound source that moves in an environment. These instructions when executed by one or more processors cause the one or more processors to perform operations as described above for the auditory scanning method described above and below.

A further understanding of the nature and the advantages of particular embodiments disclosed herein may be realized by reference of the remaining portions of the specification and the attached drawings.

### BRIEF DESCRIPTION OF THE DRAWINGS

The disclosure is illustrated by way of example, and not by way of limitation in the figures in which like reference numerals are used to refer to similar elements.

FIGS. 1a-1e are conceptual diagrams illustrating a plan view of an example setting in which various aspects of the system can be implemented to detect changing sound source location relative to a static user, where FIG. 1a shows a hearable device focusing a primary audio beam on a location of a sound source and scanning microphones use scanning audio beams to search for sound source movement, FIG. 1b shows one of the scanning audio beams detecting a first changed location, FIG. 1c the primary audio beam shifting to the first changed location and scanning audio beams shifting to search for next changed locations in other areas, FIG. 1d shows one of the scanning audio beams detecting a next changed location, FIG. 1e shows the primary audio beam shifting to the next changed location and scanning audio beams shifting to search for any further changed locations, in accordance with some implementations.

FIGS. 2a-2b are conceptual diagrams illustrating a plan view of an example setting in which various aspects of the auditory scanning system can be implemented to detect changing sound source location relative to a moving user, where FIG. 2a shows a user and sound source moving in unison, and FIG. 2b shows the sound source and user moving out of sync, in accordance with some implementations.

FIGS. 3a-3b are conceptual diagrams illustrating a plan view of an example setting in which various aspects of the auditory scanning system can be implemented to refocus to a changed location via expanding primary audio beam width, where FIG. 3a shows a primary audio beam at a sound source and displaced scanning audio beams, and FIG. 3b shows an expanded width primary audio beam to cover a changed location, in accordance with some implementations.

FIG. 3c-3d are conceptual diagrams illustrating a plan view of an example setting in which various aspects of the auditory scanning system can be implemented to detect a changed location via expanding scanning audio beam width, where FIG. 3c shows identical primary audio beam and scanning audio beam at a sound source, and FIG. 3d shows an expanded width scanning audio beam to search for a changed location, in accordance with some implementations.

FIG. 4 is a flow diagram of an example method for scanning an environment to refocus a hearable device onto a changed location of a sound source, in accordance with some implementations.

FIG. 5 is a flow diagram of an example method of using an artificial intelligence model to predict sound source movement, in accordance with some implementations.

FIG. 6 is a flow diagram of an example method of training an artificial intelligence model to predict sound source movement, in accordance with some implementations.

FIG. 7 is a conceptual diagram illustrating an example of hearing aid type hearable device with placement of primary microphones and scanning microphones, in accordance with some implementations.

FIG. 8 a block diagram of components of the auditory scanning system across a network, in accordance with some implementations.

FIG. 9 is a block diagram of a hearable device of the auditory scanning system usable to implement in the processes of FIGS. 4-5, in accordance with some implementations.

### DETAILED DESCRIPTION OF EMBODIMENTS

The present auditory scanning system enables a hearable device to focus on a sound as the source of the sound moves to different locations relative to a user of the hearable device. Various listening parameters, such as beamforming elements, are manipulated to focus on a direction of a sound source in the environment of the user. Certain microphones associated with the hearable device carry out specific functions which can seamlessly track the sound source as it moves around the environment. Primary microphones can maintain focus on a primary focus area in the last known direction of the sound source. Sound from the primary microphones are fed to the user as the sound that the user hears. In the meanwhile, scanning microphones may search the environment for the moving sound source at changing locations. For example, the scanning microphones may alternate between focusing on a last known direction of the sound source and intermittently scanning the environment for a changed position. The strengths and other sound wave characteristics may be compared to detect changed locations of the sound source. In some implementation a sound wave assessment artificial intelligence (AI) model may be employed to discern distortion in sound wave patterns and identify sound source movement.

Once a changed location is detected and/or predicted, the listening configuration of the hearable device may change dynamically to accommodate changing sound source locations relative to the user. Listening parameters are shifted to refocus the primary microphones on an area in the direction of the new changed location. The process may continue with scanning microphones resuming to scan for additional location changes of the sound source. In some cases, an artificial intelligence model may be employed to predict location changes using movement patterns of the sound source.

Listening parameters may include beamforming elements to adjust signal processing and selectively tune onto a particular sound and/or direction of a sound. For example, listening parameters may include physical adjustments to shape and move certain microphones. Listening parameters may also include electrical adjustments such as using an analog delay circuit for scaling or phase-shifting analog signals, summing, and digitizing an output data stream. Mathematical adjustments may be employed by software algorithms to adjust digital signal processing, such as applying weights to achieve a desired sensitivity pattern. Other listening parameters are possible for focusing listening effects on the user toward sound coming from a particular direction.

The “user” of the auditory scanning system as applied in this description, refers to at least one person that uses the hearable device of the auditory scanning system to assist in hearing sounds from at least one sound source in the environment of the user. The sound source can be any item that moves locations in an environment and emits a target sound to which the hearable device focuses. For example, the sound sources can be persons, vehicles, animals, elements in nature, mechanical and/or electronic devices, and other articles that move and make sounds.

The term “movement” is used to describe a change in physical location of an object such as a sound source and user. The term “changed location” and variations thereof may includes a change in a horizontal direction, a vertical direction, a forward direction and/or a backward direction from a prior known location of the sound source. A change in location of a sound source is considered relative to the location of the user. Thus, when both the sound source and user are moving at a same or similar position relative to each other (such as moving at substantially the same speed and distance from each other), the sound source may not be considered to have changed locations. The term, “relative to the user” more specifically refers to the position of the hearable device and associated microphones worn by the user.

It is assumed that the hearable device is generally in a fixed or substantially fixed position on the user during the scanning process. However, a user shifting a part that wears the hearable device, such as the head of the user, is considered nominal and may not contribute to the change of location of the sound source. A change in position of the sound source may be recognized when the movement is outside of a primary focus area of the hearable device.

A sound that is the target of focus may be a continuous noise from a sound source or may be intermittent with brief times of no sound. The term “sound” may also include the plural and sound waves that represent the sound. Thus, the terms “sound” and “sound waves” are used interchangeably in this description.

The present auditory scanning system addresses issues that can arise when using other types of hearing devices. For example, other such devices often aim microphones to a space immediately in front of the user of such prior systems. For such prior technologies, a sound from a moving sound source may be lost or less audible to the user of the hearing device. Such other devices may rely on vision of the user to move the user head or position to find the sound source and reestablish the sounds source in front of the user. Some users may not be able to visually track the sound source movements. Important sounds, such as a conversation, may be sacrificed in the process or need to be repeated for the user to hear the sound.

The present scanning hearable system circumvents such problems by providing efficient scanning and automatic refocus mechanisms that allow for maintained focus on a last known sound location while scanning for changed locations. The technological improvements include continuous sound presented to a user through the hearable device, in which refocusing can appear seamless without disruptive down time.

The present scanning system provides additional benefits and avoids prior limitations, which will be apparent by this description.

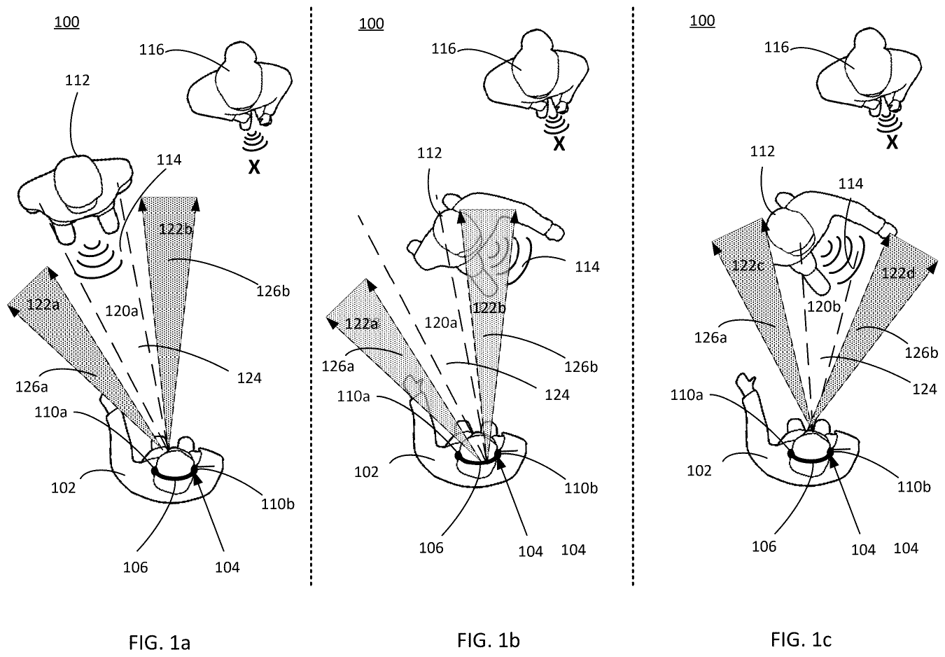

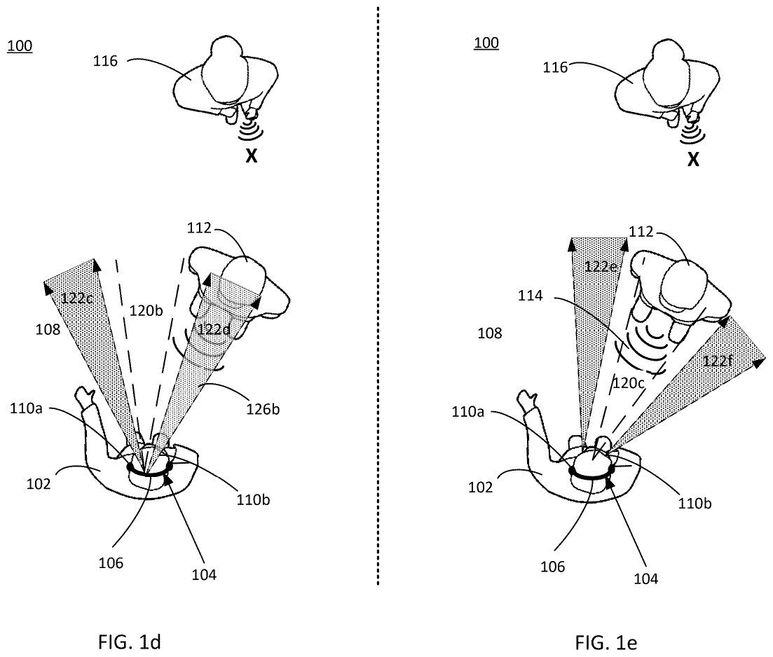

FIGS. 1a, 1b, 1c, 1d, and 1e are sequential time frames of an example use case of the auditory scanning system 104, via pan views of an environment 100. The auditory scanning system 104 includes a hearable device 106 employed by a user 102 in a static position in the environment 100 to facilitate the user 102 to listen to a sound 114 emitted by a moving sound source 112 who is a person.

The present auditory scanning system 104 adjusts listening parameters to focus on the direction of the sound source at a particular location by engaging certain hearable device resources, e.g., primary microphones, software algorithms, electrical components, etc. Sound waves captured by the microphones may have characteristics that indicate location of the source of the sound. While focus of the primary hearing elements are maintained in the last known direction of the sound source, the auditory scanning system 104 engages other resources, e.g., scanning microphones, software algorithms, electrical components, etc. to scan the environment and detect when and a general location of where the sound source moves. For example, one or more scanning audio beams may be deployed to cover and capture sounds in areas displaced from a primary focus area covered by the primary audio beam. The newly captured sound waves may have characteristics that indicate that the sound source changed locations relative to the user. The system 104 refocuses listening parameters onto the changed location.

In some implementations, the sound source may be in constant motion. In such cases, the auditory scanning system 104 may initially focus at a first direction toward a sound source and then immediately track movement with scanning microphones to refocus toward subsequent locations. Tracking movement may be performed as a predictive process by employing a movement artificial intelligence (AI) model trained to anticipate future movements of a sound source. In still some implementations, a sound source may move only once or periodically change locations. In such instances, focus may be at a first direction and after a stationary period of time, the sound source may be detected at another location and the system refocuses at the changed direction, and so on. The AI model may be employed to predict next future movements likely to occur at particular time periods. By actively searching for a moving sound while directing focus on the last known direction of the sound source, the auditory scanning system 104 enables the user to almost seamlessly hear the sound at various locations.

Various types of a hearable device 106 may be used in the auditory scanning system 104. As depicted in FIGS. 1a-1e, a headphone type hearable may be binaural. The hearable device 106 includes microphones (not shown) which may be coupled to a left hearing unit 110a and right hearing unit 110b worn over the respective ears of the user 102 and coupled to each other via a band 106. The microphones may also be coupled to a microphone component attached to the hearable device 106.

In FIG. 1a, the user 102 listens to speech sounds 114 with the assistance of hearable device 106 from a sound source that is a person 112 in a first location in the environment 100. Primary microphones associated with the hearable device 106 capture the speech sound waves by adjusting listening parameters to form a primary audio beam 124 (beamforming) onto a primary focus area 120a in the direction of the sound source person 112. Two or more primary microphones may be provided. The primary focus area 120a may be an area having a cone shape, rectangular shape, or other shape and having various dimensions, e.g., widths, lengths, heights, in the environment 100. In some implementations, the shape and/or dimensions of the audio beam may be varied by the hearable device to optimally capture sounds 114.

In some implementations during an initial time period, two or more scanning microphones associated with the hearable device 106 may be provided and may be focused in a base position that is congruent with the primary microphones on the direction of the last known location of the sound source. In this base position, the scanning microphones may use similar listening parameters as the primary microphones to form audio beams such that all microphones are focused on the same point in the environment.

In other implementations, the two or more scanning microphones may consistently form audio beams outside of the primary focus area to constantly scan for movement of the sound source, rather than intermittently pairing focus with the primary microphones. Thus, as a changed location of the sound source is found and primary microphones shift focus on the direction of the changed location, the focus of the scanning microphones also shift to new areas of the environment. The scanning microphones may steer the scanning audio beams in xyz directions to various areas outside of the primary area, such as up/down (vertical), left/right (horizontal), and/or forward/backward. Such constant scanning steps may be useful for quick and/or continuously moving sound sources.

In a next time period, while the primary microphones maintain focus of the audio beam in the primary focus area, the scanning microphones shift focus using the audio beam forming techniques to focus listening parameters onto two scanning areas 122a and 122b outside of the primary focus area targeted by the primary microphones in the environment. In some implementations, scanning microphones coupled to the left hearing unit 110a may form scanning audio beams toward the scanning area 122a displaced at a horizontal distance from the primary focus area 120a on the side closes to the left hearing unit 110a. Likewise, scanning microphones coupled to the right hearing unit 110b may form scanning audio beams to search the other scanning area 122b may be displaced from the primary focus area 120a in an opposite horizontal distance closes to the right hearing unit 110b.

In the example in FIGS. 1a-1c, a background sound source 116 is also located in the environment 100 of the user. The auditory scanning system 104 does not focus on the background sound by forming a primary audio beam 124 that covers the location of the background sound source 116. For example, the background sound and/or background sound source 116 may be determined to be unimportant or less important than the sound source 112 and/or speech sound 114 of the sound source to the user. Thus, the hearable device may accentuate listening effects of the speech sound 114 with the listening parameters including the primary audio beam 124 in the primary focus area 120 and diminish listening effects of other sounds in the environment including the sound of the background sound source 116 using the listening parameters.

At a next time period shown in FIG. 1b, the sound source person 112 moves into a second location of the environment in the scanning area 122b and makes speech sounds 114. While the primary microphones temporarily maintain the primary audio beam 124 focused on the last known direction of the sound source, the scanning microphone corresponding to the scanning area 122b detects the sound 114 from the sound source person 112 with a scanning audio beam 122b. The scanning microphones may be triggered to initiate scanning by various events, such as the sound detected as decreasing in volume at the primary focus area, a change in signal to noise ratio, sensors detecting sound source movement, etc.

In the next sequential time frame shown in FIG. 1c, refocusing steps result in audio beam adjustments. The primary microphones shift the primary audio beam 124 on the direction of the changed location to form a new primary focus area 120b, thereby refocusing listening parameters onto the moved sound source.

In some implementations that employ intermittent scanning steps, the scanning microphones temporarily maintain focus on the last known direction of the sound source to merge the scanning area with the primary focus area during a focus time period, such as 15-60 seconds. After the focus time period where all microphones are fixed with audio beams (primary and scanning) at the last known sound source location, the scanning microphones may continue scanning the environment for a next movement of the sound source for the next scanning period of time, such as 5-10 seconds, and then temporarily jump back to the primary focus area (may repeat process until scanning stops). In other implementations that employ constant scanning steps as described above, the merging of focus areas is skipped and the scanning microphones continuously scan for sound source movement outside of the primary focus area.

The scanning microphones continue to scan by forming scanning audio beams in the environment within scanning audio beams 126a, 126b at new scanning areas 122c and 122d displaced from the direction of the primary audio beam 124.

In FIG. 1d, the sound source person 112 continues to move into a third area of the environment in the scanning area 122d and make speech sounds 114, which are detected by corresponding scanning microphones forming a scanning audio beam 126b to cover scanning area 122d.

In FIG. 1e, once again, the primary microphones shifts to form the primary audio beam 124 in the direction of the changed location to form a new primary focus area 120c. The scanning microphones continue to scan within new scanning areas 122d and 122f using scanning audio beams 126a and 126b, respectively.

The scanning microphones may scan one or more areas at a time. In some implementations, the scanning microphones may sequentially skip from scanning area to scanning area at predefined intervals, repeating until a changed sound source location is detected. For example, scanning microphones may periodically scans the environment for sounds by forming scanning audio beams in different directions at incremental angles from the last known direction of the sound source until sound waves are captured by the scanning microphones that indicate a moved sound source. Once a changed location of the sound source is detected, the primary microphones shift the primary audio beam 124 on the new direction.

Other hearable devices may be employed, such as monaural devices with microphones adjacent to one ear. Types of hearable devices can also include earbuds worn at one or both ears of a user, one or a pair of hearing aids, etc. The hearable device may be inserted into the ear, implanted into the ear, worn over part of the head, such as a hat or band, etc., with externally positioned microphones. Hearable devices may include multiple functional devices, such as recreational earbud or headphones that also include medical grade hearing aid functionality. The hearable device may also be a component of a wearable system including other devices, such as smart glasses, smart watch, etc.

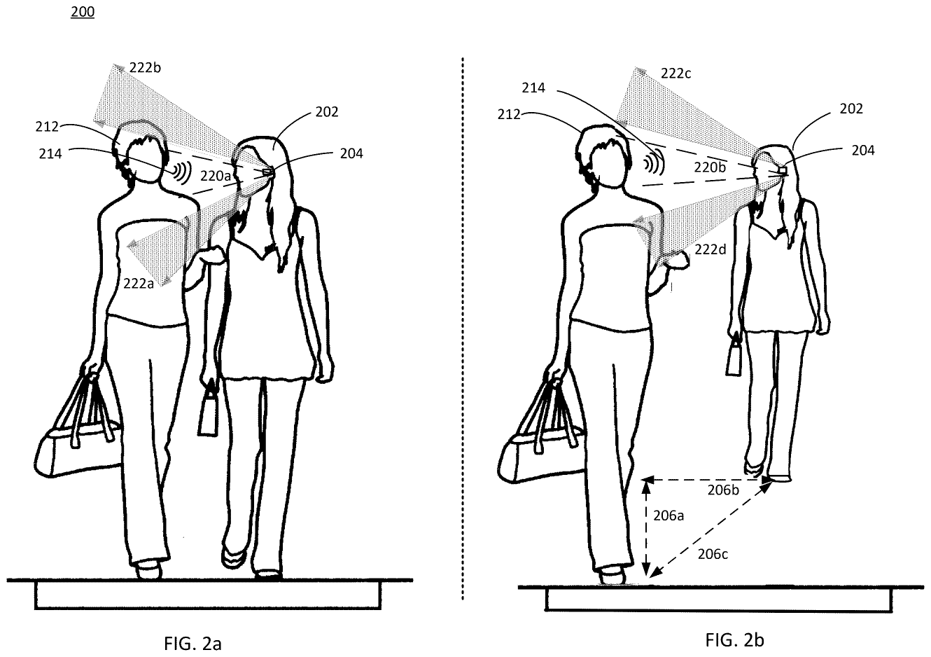

As shown in FIGS. 2a, 2b via sequential time frames representing different time periods, an example use case of the scanning system 204 is illustrated in which both a user 202 and a sound source person 212 walk together. Changes in the detected location of the sound source person 212 are relative to a given location of the user 202 at a point in time. For example, the sound source may slow down, increase pace, and/or change directions without the user doing the same. In some situations of both the user and sound source moving relative to each other, the sound source may continue along a same or changed trajectory at the same or changed pace, and the user may then slow down, increase pace, stop or change directions without the sound source doing the same. Such examples of changes in movements may be detected as a change in location of the sound source relative to the user.

In the example in FIG. 2a, the user 202 and sound source person 212 both move in unison along a same path or direction, at a same or similar velocity, and maintain a same or similar distance from one another. As such, there may not be a threshold amount of change in location of the sound source relative to the location of the user 202 to trigger refocus of the hearable device. The sound source location is within the primary focus area 220a of an audio beam formed by hearing aid 204 worn by the user 202. For example, the audio beam may cover a primary focus area 220 a of about 10-30 degrees, and more particularly 15-20 degrees from the hearable device. As long as the sound source remains within the primary focus area, the hearable device may not need to perform refocusing steps to change the listening parameters. Opposing scanning areas 222a and 222b may be angled 5 or more degrees from the primary focus area 220a, and more particularly 10-30 degrees from the primary focus area 220a.

At times, the sound source may change locations relative to the user outside of the present primary focus area to trigger refocusing steps. For example, the user may stop moving while the user continues to move, or the sound source changes speed (e.g., slows down or speeds up) and/or directions relative to the user. In FIG. 2b of the present example,, the user 202 and sound source person 212 move out of sync with one another. Refocusing of the primary audio beam is triggered by the sound source person 212 detected as located ahead of the user 202 that is outside of the primary focus area 220a and within the scanning area 222a. The sound source person 212 may walk faster than the user 202, the user 202 may walk slower than the sound source person 212, or the user may stop moving. A greater distance in the y direction, shown by vertical ray 206a, and a greater distance in the x direction, shown by horizontal ray 206b between the user 202 and sound source person 212, results in a greater angled distance shown by diagonal ray 206c.

The hearable device 204 adjusts the primary microphones to form an audio beam to focus capture of the speech sound 214 within the changed primary focus area 220b. The scanning microphones form audio beams to cover respective changed scanning areas 222c and 222d.

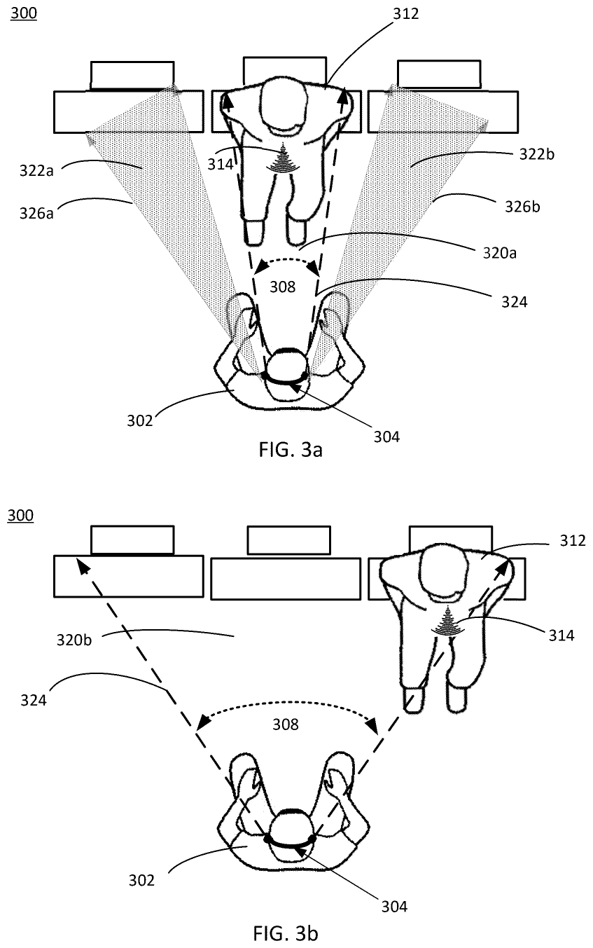

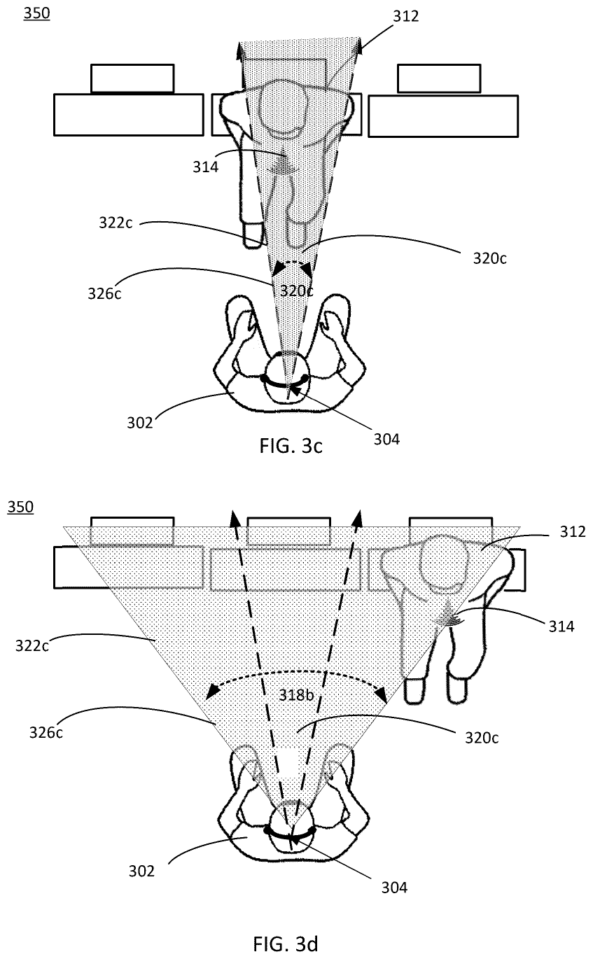

FIGS. 3a, 3b show sequential time frames during different time periods of an environment 300 illustrating an example use case of the auditory scanning system 304 in which audio refocus onto a changing location of sound source 312 includes forming an expanded primary audio beam width. In FIG. 3a, hearable device 304 worn by user 302 adjusts listening parameters, including using primary microphones and forming primary audio beam 324 in primary focus area 320a to focus onto target sound 314 of sound source 312. The primary focus area 320a covered by primary audio beam 324 is narrow to encompass the sound source 312 in a first location. Scanning microphones form scanning audio beams 326a, 326b to capture sounds in scanning areas 322a and 322b.

When sound source 312 moves chairs to a changed location within scanning area 322b, the corresponding scanning microphones capture the sound waves of the target sound 314. In FIG. 3b, the primary microphones of the hearable device expand the width 308 of the primary audio beam 324 to enlarge the primary focus area 320b to encompass the previous scanning area 322b in the previous direction of the right scanning audio beam 322b. The resulting primary audio beam enables the primary microphones to capture the sound 314 of sound source 312 in the changed location.

In FIGS. 3c and 3d, show sequential time frames during different time periods of an environment 350 illustrating an example use case of the auditory scanning system 304 worn by user 302 in which a changed location of the sound source 312 is detected via an expanding width of a scanning audio beam 326c. In some implementations, the scanning audio beam may be repeatedly expanded by increasing width of the scanning audio beam 326c and compressed to return to an original width. For example, as shown in FIG. 3c, the scanning audio beam 326c may initially be identical to the primary audio beam 322c, as being in the same direction, same width 318a (depicted as dotted double arrow line), and covering the same primary focus area 320c.

The scanning audio beam 326c may be iteratively widened from the original width 318a covering a primary focus area to an expanded width 318b (depicted as longer dotted double arrow line) shown in FIG. 3d. In some implementations, the scanning audio beam 326c may return to the original width and direction (as in FIG. 3c) if the second sound waves are undetected, for example, after a predetermined period of time. The expanding scanning process may repeat to continue searching for a sound source movement. Where a changed location is found, as in FIG. 3d, the primary audio beam 322c may be refocused by the primary microphones by shifting the primary audio beam 322c to the direction of the changed location or widening the primary audio beam as shown in FIG. 3b.

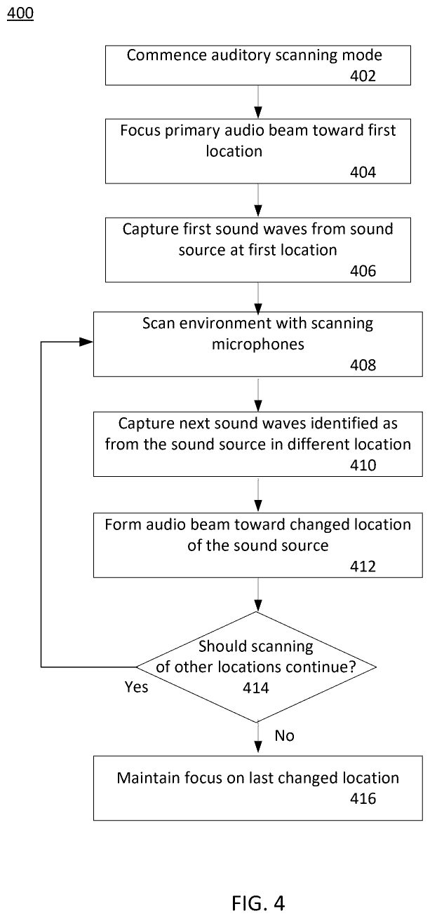

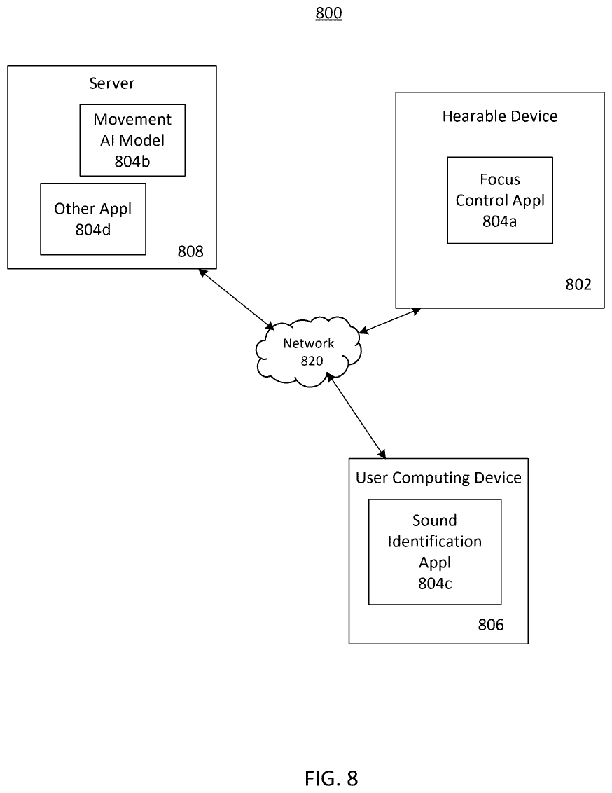

FIG. 4 shows a flow chart of an auditory scanning process 400 performed by the scanning system, for example system 800 shown in FIG. 8. The hearable device may be initially focused on a sound source in a recognized location relative to the user, such as passively focusing on a sound source in a base position, e.g., immediately in front of the user, prior to activation of a scanning mode of the scanning system. In some implementations, other triggers to initiate the hearable device to focus on a particular sound source may include user gestures, voice commands, sound source recognitions, etc. For example, the hearable device may be configured to detect or receive signals for detected user gestures, such as eye gaze, nod, or pointing toward a sound source.

In block 402, the auditory scanning system commences to run in a scanning mode in which scanning resources, e.g., scanning microphones, scanning software instructions, movement prediction AI model, and other listening parameters are activated to track movement of a sound source in an environment of a user.

The scanning mode may be manually activated by the user such as the user touching a spot or button on the hearable device, speak a command, or perform gesture, e.g. head nod. Activation of the scanning mode may also be automatically triggered by an event without the need for manual user activation. For example, the scanning mode may be triggered by the auditory scanning system 104 recognizing a sound source as matching stored sound source identifying information in which the known sound source has a history of changing locations, or an attribute that indicates a propensity to change locations, based on sound source data stored in memory. Other scanning mode trigger events may include detection of a particular environment, a scheduled date and time, user activity associated with a moving sound source, such as the user walking with the sound source or the user watching a live performance, etc. Activation of scanning mode may be accompanied by a notification to the user, such as voice output indicating scanning mode is on. In still some implementations, the auditory scanning system 104 may automatically perform the scanning process without the need for scanning mode activation.

In some implementations, the scanning mode may be triggered by one or more sensors, e.g., camera, LiDAR technology, ultrasonic sensors, etc., that detect movement of a sound source outside of the primary focus area. Such sensors may be external to and in communication with the hearable device. For example, a computer device, such as a smart phone, smart watch, image capture device (e.g., camera), etc. may feed information to the hearable device, such as via Bluetooth audio signals e.g., radio waves, as described below by item 806 with regards to FIG. 8.

In block 404, a primary audio beam is focused in a direction toward a first known location of the sound source. The first location of the sound source may be detect by various mechanisms, such as the sensors described above for triggering the scanning mode, manually by a user, detecting gestures of the user toward a sound source, identification of sounds captured from the sound source, etc. Other sound localization technologies may be employed.

The sound source location in the environment may be specified in terms of general direction or more specifically in terms of x, y, and/or z coordinates from the user, or according to a range of coordinates or angles from the user. In some implementations, the primary focus area covered by the audio beam has a width and depth to cover sufficient space that an exact location need not be identified and a general direction may suffice.

In block 406, first sound waves from the sound source are captured by primary microphones from an initial location focused on an initial direction. In some implementations, scanning microphones are also set to capture the first sound waves for a period of time. During another time period, in block 408, at least some of the scanning microphones skip from the initial direction and scan the environment to detect potential next sound waves that may indicate that the sound source moved locations. Scanning of the environment includes the scanning microphones forming scanning audio beams at various locations in the environment.

In some implementations, scanning of the environment may be take place according to a predefined scheduled, such as a time that a sound source is expected to move. In some implementations, scanning may be triggered by a relocating event, such as a sensor, e.g., camera detecting sound source movements, indicating the sound source is moving or about to move. In still some implementations, scanning may be in response to analysis of sound wave data indicating movement of the sound source. For example, a pattern of the sound waves captured by microphones at a hearing unit at one ear may be compared to sound wave patters captured at the other hearing unit at the other ear. The difference in the wave patterns, such as an increase or decrease in amplitude, between ears may indicate that the sound source is moving from one horizontal direction of one ear to the other horizontal direction proximal the other ear.

In some implementations, the scanning may be performed repetitively at different areas of the environment until a changed location of the sound source is detected. Iterations of forming the scanning audio beam may be at incremental direction angles, such as 10 to 45 degrees, or more particularly 10 to 20 degrees from a prior scanning direction or from the primary focus area. In some implementations, the scanning microphones may temporarily return focus back to the direction of the primary focus area between iterative scanning steps.

In block 410, at least some of the scanning microphones capture further sound waves that are determined to be from the sound source moved to a different location. For example, sound waves from the primary microphone may be compared with the sound waves captured by the scanning microphones. In some implementations, the identifying sound characteristics may be compared with stored identifying characteristics, e.g., kept in a sound source library. A match of identifying sound wave characteristics may confirm that the sound waves captured by the scanning microphones in a scanning area are those of the sound source.

Once the system determines that the sound waves captured by the scanning microphones are those of the sound source, the scanning system may determine that the sound source has moved locations by comparing relocating sound characteristics. During a same time period, the relocating sound characteristics of the sound captured by the primary microphones may be contrasted with the relocating sound wave characteristics of the sound capture by the scanning microphones. For example, a decrease in amplitude of sound waves from the primary microphone compared to an increase in amplitude with the second sound waves from the scanning microphones during the scanning period. In block 412, the primary microphones form primary audio beam toward the changed location.

In decision block 414, it is determined whether further locations are to be scanned for additional movement by the sound source. Where no further source movement is expected, the process may proceed to block 416 to maintain focus on the last changed location of the sound source. In some implementations, a stopping event may occur to deactivate the scanning process. For example, the scanning mode may be manually turned off (for example, by user gestures, voice commands, touch, etc.) or automatically turn off based on stopping criteria, such as expiration of a scanning time. In some implementations, the stopping event may be detection that the sound source may have left the environment or otherwise stopped emitting noise for a threshold period of time. For example, the sound source may pause emitting sound for a defined pause period, the scanning process automatically stops. In some instances, if the sound source resumes emitting the sound within the pause period, the hearable device may remain focused on the last known location of the sound source and continues scanning for sound source relocation. In some implementations, the scanning system may output a notification to the user that the scanning mode is deactivated, such a voice output indicating scanning mode is off.

Where the scanning process is to continue, the process moves back to block 408 to scan the environment with the scanning microphones focused on scanning areas different from the last scanned area.

Variations of the scanning process in FIG. 4 are possible. For example, where multiple sound sources are tracked in the environment, the primary and/or scanning microphones may alternate audio beams from sound source to sound source, or may expand the width of the audio beams to cover the various sound sources, as described in FIGS. 3a-3d.

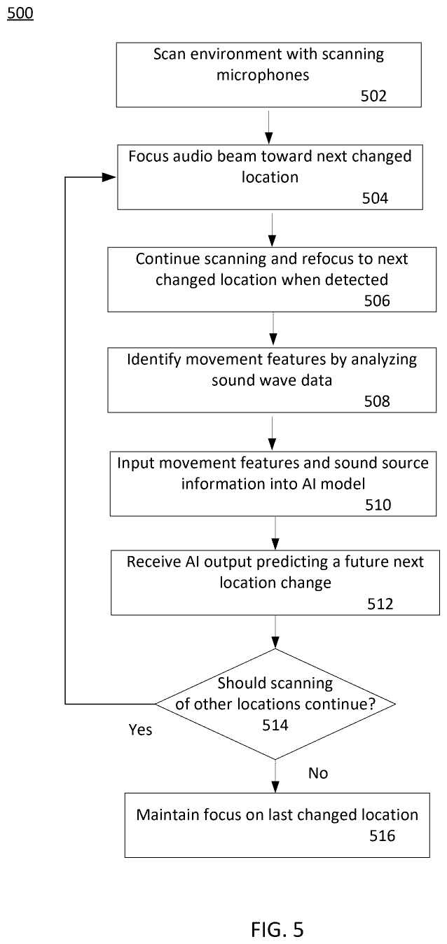

FIG. 5 is a flow chart of a scanning process 900 that uses an AI model to predict sound source movement for refocusing the hearable device. The scanning process 900 is performed by the auditory scanning system for example system 800 shown in FIG. 8. The scanning process shown in FIG. 5 assumes that the scanning system is focused with primary microphones in the direction of a first known location of the sound source, for example as in blocks 402-406 in FIG. 4.

In block 502, scanning microphones scan the environment of the user and pick up on sound waves from the sound source in a changed location. The scanning process may include determining that the sound waves from the scanning microphones are those of the sound source, for example, as in block 410 of FIG. 4. The focus audio beam is formed in the direction of the changed location of the sound source in block 504, for example, as in block 412 of FIG. 4.

In block 506, the scanning microphones continue scanning for any next changed location of the sound source and the system refocuses primary resources onto the next changed location of the sound source, for example, as in blocks 410-412 of FIG. 4.

In block 508, movement features of the sound source may be identified. For example, movement data associated with movement of the sound source may be analyzed to determine patterns in changes in direction, velocity, etc., to be used as movement features. Other movement features may be extracted by analyzing the sound wave data, such as levels and patterns of amplitude changes, frequency levels and patterns, etc.

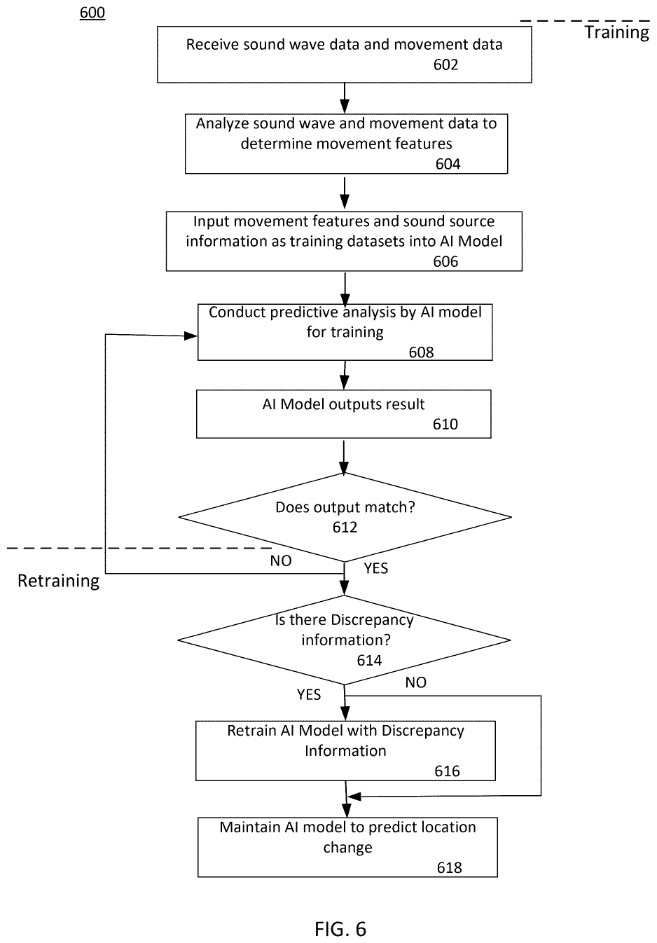

In block 510, the movement features and additional information related to stored information may be input into one or more AI model(s). The additional information may include sound source identifying information and/or the sound, such as identification/type of the sound source and past movement patterns of the sound source. In some implementations, situational information may also be input into the AI model. Situational information may indicate the circumstances of the sound source emiiting the sound, such as characteristics of the environment, date/time of the sound, weather conditions, an event occurring in the environment, actions by the sound source, etc., The AI model may be trained according to the training process described below with regards to FIG. 6.

In some implementations, movement features may be unnecessary as input data for the AI model. The identification of the sound source and situational formation may be used as input without the movement features for the AI model to predict likely movement of the sound source. Where a sound source is known to make regular movements in a particular environment and/or at a particular date or time, the AI model may predict changing locations. For example, an emergency vehicle identified as a sound source traveling on a road at a certain speed may be predicted to continue along the path of the road.

In block 512, output of the AI model is received and includes predictions as to whether additional movement of the sound source is likely and if so, the trajectory of movement, and/or the future next location change is predicted to occur at a particular time.

In decision block 514, it is determined whether scanning for a next location should continue. If additional location changes are expected, the process returns to block 504 to focus the primary audio beam in the direction of the predicted changed location of the sound source, according to the AI model output results. In some implementations, the AI model output includes a time period in which the predicted change is likely to occur and the primary audio beam is directed to the location at the predicted time.

Where there are no further source movement expected, the process may proceed to block 516 to maintain focus on the last changed location of the sound source.

FIG. 6 shows a flowchart of an example training process to train the AI model to predict likely changed locations of sound source movements. In some implementations, the techniques to train the AI model may employ supervised classification algorithms, such as logistic regression algorithms. In some implementations, unsupervised or semi-supervised techniques may be employed.

In block 602, sound wave data associated with a sound source and movement data associated with characteristics of movements of the sound source are received or otherwise accessed for assessment/training purposes. The sound wave data and movement data may also correspond with sound emitted from the sound source under various situations that may be the basis of situational information, such as movements in an environment, under specific conditions, and/or at certain days and/or times of days.

In block 604, various data are analyzed to determine movement features. For example, sound wave data may be examined to extract movement features from the sound wave data. For example, movement features may include patterns of data, levels and patterns of amplitude changes, frequency levels and patterns, characteristics of the repetition of patterns, etc. Movement data describing sound source movements may also be analyzed to determine movement features such as patterns in changes in direction, velocity, etc.

In block 606, training datasets are inputted into the movement prediction AI model. Such training datasets include the movement features and identification information characterizing the sound source, such as name, type, demographics, and other characteristics of the sound source, which may influence sound emitted from the sound source and/or possible movement of the sound source. In some implementations, the situational information that describe the circumstances of the sound source emitting the sound may also be inputted as training datasets, such as characteristics of the environment, date/time, weather, events, sound source actions, etc. associated with the emitting of the sound.

In block 608, the AI model conducts predictive analysis using the training datasets. The training of the AI model may include determining patterns in types of speech, listener characteristics, etc., that leads to positive predictive results. Based on the analysis, the AI model outputs a result of the analysis in block 610. The output result includes identification of a future location for the sound source and may also include a time of such likely change.

In decision block 612, the output result is compared with the training dataset inputted into the AI model and predetermined expected output result, to determine whether the output result matches. It is determined whether a threshold of success is achieved by the output result. The threshold of success may specify that some value equal to or less than 100% accuracy (such as 80%-90% success rate) is acceptable output results to be used.

If it is decided in decision block 612 that the output results match the training datasets to meet the threshold of success, the process continues to decision block 614 described below. If there is a finding that the output results fail to match according to the threshold of success, the AI model is retrained by returning to block 608 and conducting predictive analysis again until the output result matches the training dataset. If a match is not achieved after a threshold number of tries, the analysis algorithm and/or training dataset may be assessed to find a solution to the failures.

In decision block 614, it may be determined whether there is discrepancy information from prior AI model output results, in which the output of particular prompts was found to fail a threshold level of success in predicting sound source movements. Discrepancy information may include feedback from an external support resource, quality control studies, user survey data, failure reports, etc. The discrepancy information may be used for retraining in block 616. After discrepancy information retraining is complete, the process proceeds to block 618 described below.

If no discrepancy information is received, the process skips the discrepancy information retraining and continues to block 618 to maintain the AI model for future use in predicting attention requiring noises. For example, the AI model may be trained at a computer processing system independent from the scanning system. The scanning system may receive the AI model when needed to be applied to a scanning process, e.g., upon receiving the sound waves from the target sound source, upon activation of the scanning mode, etc.

The processes of FIGS. 4, 5, and 6 described herein or variations and/or combinations of those processes, can be performed via software, hardware, and combinations thereof may be performed under the control of one or more computer systems configured with executable instructions and/or other data, and may be implemented as executable instructions executing collectively on one or more processors. Although the description has been described with respect to particular implementations thereof, these particular implementations are merely illustrative, and not restrictive. Additional steps may be added, steps may be removed, and/or the order of steps may be varied.

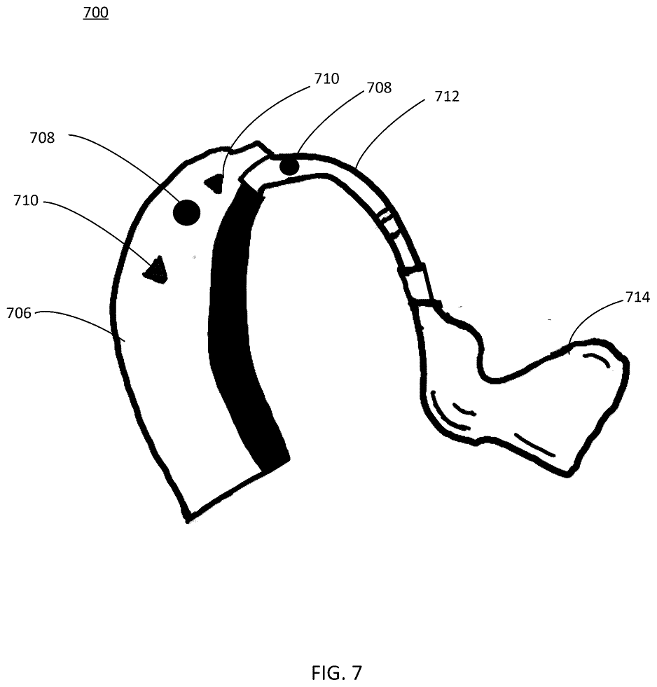

FIG. 7 shows an example of type hearable device that is a hearing aid 700 with placement of primary microphones 708 and scanning microphones 710 dispersed along a base portion 706 and tube portion 712 connecting the base portion 706 to an earmold 714 (or “ear dome”) of the hearing aid 700. The earmold 214 includes a receiver to convert electrical signals from sound picked up by the microphone into audible sound for the user to hear.

The various microphones 708,710 are fixed in positions that may be vertical and/or horizontal offset relative to one another to facilitate sound capture at various areas of the environment. Additional microphones may be used in the hearing aid 700. The vertical and horizontal positions of the microphones are used in conjunction with a position of the target sound source to determine a direction of focus for each microphone.

Other configurations of the hearable device may be employed and are considered within the scope of this disclosure. For example, various designs and configurations of a hearing aid, headphones, earbuds, etc. may be used that include multiple primary microphones and scanning microphones and implement the scanning software applications described herein.

FIG. 8 shows a block diagram of components of one example implementation of the auditory scanning system 800 by which various of the steps of the scanning processes describe with regards to FIGS. 4-5 may be performed. In the illustrated implementation, components of the auditory scanning system 800 includes a hearable device 802 and may include a user computing device 806, and/or a server 808, which may be connected via network 820.

The hearable device 802 includes a focus control application 804a that includes instructions to control various listening parameters of the hearable device including the scanning microphones, the primary microphones, and other elements of the scanning and focusing processes. In some implementations, the software functions of the scanning system may reside onboard the hearable device. In other implementations, certain processes may be offloaded to the server 808 and/or user computing device 806 or a combination of steps may be performed by the various applications.

Computing device 806 may communicate with hearable device 802 and may identify a target sound source via sound identification application 804c. The sound source analysis may be performed by the sound identification application 804c. The focus control application 804a may request the user computing device 806 to perform sound source identification steps through the sound identification application 804c.

For example, the sound identification application 804a may extract identifying information from captured in images of the sound source and search one or more libraries or send the identifying information to the server to search for a corresponding sound source, e.g., via other application(s) 804d.

The server may also include a movement AI model 804b to predict likely location changes by the sound source. For example, identified sound source information may be used by the movement AI model 804b as described above with regards to process 500. Output results of the movement AI model may be communicated to the hearable device 802 via network 820.

The network 820 may include a local area network, a wide area network, a wireless network, an Intranet, the Internet, a private network, a public network, a switched network, cellular, wired connections, or any other communication network, such as for example Cloud networks, suitable for connecting the components. For communication of some system components, the network 820 may include a short-range connection between various system components, such as Bluetooth Low Energy (BLE), Bluetooth, Zigbee, etc. Other connections are possible such as wide band and ultra-wide band.

Other configurations of the scanning system 800 may be employed and are considered within the scope of this disclosure. Various designs and configurations of a hearable device may be used. For example, in some implementations, a server need not be employed, a mobile device of the user or target persons may be used for some of the processes, etc.

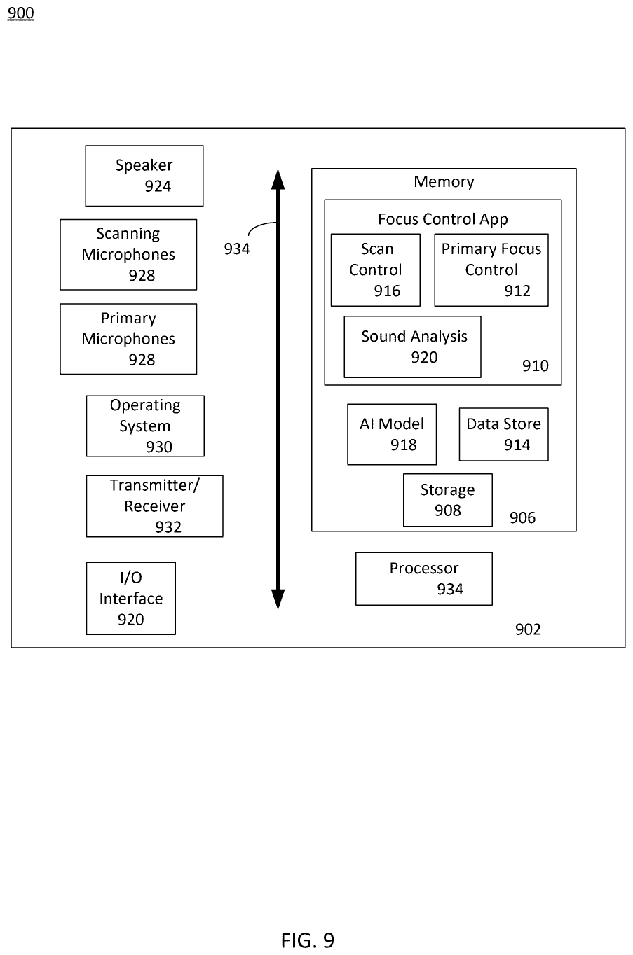

FIG. 9 shows components of one example implementation of the hearable device 900 of the auditory scanning system by way of a block diagram. The hearable device 900 includes hardware and/or software to perform operations to adjust a hearable device of a user to focus on a sound source that moves in an environment, such as operations described below with regard to FIGS. 4-5. For example, the hearable device 900 includes one or more processor(s) 934 and logic encoded in one or more non-transitory media for execution by processor(s) 934 and when executed operable to perform the operations. In other implementations, at least some of the hardware and/or software may be in other parts of the scanning system, such as user computing device 806 and/or server 808 in FIG. 8, rather than, or in addition to, onboard functions at the hearable device 900.

The focus control application 910 is stored in memory 906 and includes various modules to perform functions of the communication process. Modules of the focus control application 910 may include primary focus module 912, scan control module 916, and sound analysis module 920. Other modules are possible.

In some implementations, the focus control application 910 controls listening parameter to focus the primary microphones and in some cases the scanning microphones to a direction of a known location of the target sound source, such as in blocks 402-406 and block 412 of FIG. 4. The scan control module 916 controls listening parameters to focus scanning microphones to various directions away from the direction of the primary microphones to search for a changed location of the sound source, such as in blocks 408-410 of FIG. 4. The sound analysis module 920 to analyze sound waves and extract movement features, such as in block 508 of FIG. 5.

In some implementations, a movement AI model 918 may also be stored in memory 906 to perform predictions on likely future movement of the sound source, as in blocks 508-512 of FIG. 5. The output of the AI model may also include a time period of the likely change of location.

In some implementations, some or all of the identifying steps may be off loaded to a server. For example, libraries may be stored remotely at a server and the server may match identifying information from a sound source. The identification may be in the form of a name, nickname, object type, group name, member identification number or other unique identifier.

In some implementations, a I/O interface 920 may receive input from the user, such as user commands to operate aspects of the scanning system, e.g., activate or deactivate scanning mode, adjust speaker volume, etc. In some implementations, one hearing unit may communicate through I/O interface 920 to coordinate with another hearing unit in the pair of units of the hearable device. The I/O interface 920 may also be enabled for wireless communication, such as via Wi-Fi, Bluetooth, Bluetooth Low Energy (BLE), radio frequency identification (RFID), etc. Wireless communication by the hearable device may connect with other computing devices, such as a smart device of the user, e.g., smartphone, smart watch, etc. In some implementations, hearable device 900 may also include software that enables communications of I/O interface 920 over a network such as HTTP, TCP/IP, RTP/RTSP, protocols, wireless application protocol (WAP), IEEE 802.11 protocols, and the like. In addition to and/or alternatively, other communications software and transfer protocols may also be used, for example IPX, UDP or the like.

Other common system components may be included, such as integrated circuit (IC) and computer chip-embedded amplifier to receive sound input and convert electrical signals from the microphones to digital signals. The IC may include a digital-to-analog converter (DAC) or analog to digital converter (ADC). Power source often includes disposable and/or rechargeable batteries.

The hearable device 900 typically includes other familiar computer components such as a processor 934, and memory storage devices, such as a memory 906. A bus 934 may interconnect hearable device components.

Memory 906 may include solid state memory in the form of NAND flash memory and storage media 908. The computer device may include a microSD card for storage and/or may also interface with cloud storage server(s). Memory 906 and storage media 908 are examples of tangible non-transitory computer readable media for storage of data, audio files, computer programs, and the like. Other types of tangible media include disk drives, solid-state drives, floppy disks, optical storage media and bar codes, semiconductor memories such as flash drives, flash memories, random-access or read-only types of memories, battery-backed volatile memories, networked storage devices, cloud storage, and the like. A data store 914 may be employed to store various on-board data, such as stored identifying information of a sound source, previous movement patterns of a sound source, etc. A receiver 932 may process sound signals. The receiver decodes sounds captured via the microphones into a format for the hearing by the user.

The hearable device 902 further includes an operating system 930 to control and manage the hardware and software of the computer device 902. Any operating system 930, e.g., mobile OS, that supports the auditory scanning methods may be employed, e.g., IOS, Android, Windows, MacOS, Chrome, Linux, etc.

Computer programs are employed and when executed by one or more processors, are operable to perform various tasks of methods including the communication processes, as described above. The computer programs may also be referred to as programs, software, software applications or code, may also contain instructions that, when executed, perform one or more methods, such as those described herein. The computer program may be tangibly embodied in an information carrier such as computer or machine readable medium, for example, the memory, storage device or memory on processor. A machine readable medium is any computer program product, apparatus or device used to provide machine instructions or data to a programmable processor.

Any suitable programming language can be used to implement the routines of particular embodiments including IOS, Objective C, Swift, Java, Cotlin, C, C++, C #, JavaScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a non-transitory medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, etc. Other components and mechanisms may be used. In general, the functions of particular embodiments can be achieved by any means as is known in the art. Distributed, networked systems, components, and/or circuits can be used. Cloud computing or cloud services can be employed. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method to adjust a hearable device of a user to focus on a sound source that moves in an environment, the method performed, comprising:
capturing by primary microphones during a first time period, first sound waves from the sound source in a first location of the environment by using a primary audio beam formed to focus on a first direction relative to the user;
while maintaining the focus on the first direction, using scanning microphones to scan the environment by forming a scanning audio beam displaced from the first direction to capture second sound waves that indicate a first changed location of the sound source relative to the user during a second time period; and
forming the primary audio beam to focus on a second direction of the first changed location.

2. The computer-implemented method of claim 1, further comprising:
repetitively performing the scanning of the environment, wherein iterations of forming the scanning audio beam are at incremental direction angles from a prior scanning direction or from the first direction, until at least one additional changed location is detected.

3. The computer-implemented method of claim 1, further comprising:
detecting first sound characteristics identifying first sound waves;
detecting second sound characteristics identifying the second sound waves from the second direction; and
determining a match of the second sound characteristics with the first sound characteristics to confirm that the second sound waves are from the sound source.

4. The computer-implemented method of claim 1, further comprising:
determining movement features associated with the sound source relocating from the first changed location to at least one additional changed location;
employing an artificial intelligence (AI) model trained on known movement features, prior location changes, and sound source information, wherein the AI model uses the movement features and sound source identifying information as input and outputs a predicted changed location of the sound source for a predicted time; and
based at least in part, on the predicted changed location, forming the primary audio beam in a third direction during the predicted time.

5. The computer-implemented method of claim 1, wherein the first changed location includes a change in a horizontal direction, a vertical direction, a forward direction and/or a backward direction relative to the user.

6. The computer-implemented method of claim 1, wherein forming the primary audio beam in the second direction includes expanding a width of the primary audio beam to cover a scanning area of the scanning audio beam in the second direction.

7. The computer-implemented method of claim 1, wherein scanning of the environment includes repeatedly:
expanding a width of the scanning audio beam from an original width consistent with the width and direction of the primary audio beam, to cover a scanning focus area; and
returning to the original width and direction if the second sound waves are undetected.

8. The computer-implemented method of claim 1, wherein the scanning of the environment is performed according to a predefined schedule when the hearable device is in a scanning mode.

9. The computer-implemented method of claim 1, further comprising:
analyzing the second sound waves to detect a degradation pattern between scanning microphones of a first hearing unit at a first user ear and a second hearing unit at a second user ear to determine the second direction.

10. An auditory scanning system, the system comprising:
a hearable device comprising:
primary microphones and scanning microphones;
one or more processors; and
logic encoded in one or more non-transitory media for execution by the one or more processors and when executed operable to perform operations comprising:
capturing by the primary microphones during a first time period, first sound waves from a sound source in a first location of the environment by using a primary audio beam formed to focus on a first direction relative to a user of the hearable device;
while maintaining the focus on the first direction, using the scanning microphones to scan the environment by forming a scanning audio beam displaced from the first direction to capture second sound waves that indicate a first changed location of the sound source relative to the user during a second time period; and
forming the primary audio beam to focus on a second direction of the first changed location.

11. The auditory scanning system of claim 10, wherein the operations further comprise:
repetitively performing the scanning of the environment, wherein iterations of forming the scanning audio beam are at incremental direction angles from a prior scanning direction or from the first direction, until at least one additional changed location is detected.

12. The auditory scanning system of claim 10, wherein the operations further comprise:
determining movement features associated with the sound source relocating from the first changed location to at least one additional changed location;
employing an artificial intelligence (AI) model trained on known movement features, prior location changes, and sound source information, wherein the AI model uses the movement features and sound source identifying information as input and outputs a predicted changed location of the sound source for a predicted time; and
based at least in part, on the predicted changed location, forming the primary audio beam in a third direction during the predicted time.

13. The auditory scanning system of claim 10, wherein forming the primary audio beam in the second direction includes expanding a width of the primary audio beam to cover a scanning area of the scanning audio beam in the second direction.

14. The auditory scanning system of claim 10, wherein scanning of the environment includes repeatedly:
expanding a width of the scanning audio beam from an original width consistent with the width and direction of the primary audio beam, to cover a scanning focus area; and
returning to the original width and direction if the second sound waves are undetected.

15. The auditory scanning system of claim 10, wherein the operations further comprise:
analyzing the second sound waves to detect a degradation pattern between scanning microphones of a first hearing unit at a first user ear and a second hearing unit at a second user ear to determine the second direction.

16. A non-transitory computer-readable storage medium carrying program instructions thereon for adjusting a hearable device of a user to focus on a sound source that moves in an environment, the instructions when executed by one or more processors cause the one or more processors to perform operations comprising:
capturing by primary microphones during a first time period, first sound waves from the sound source in a first location of the environment by using a primary audio beam formed to focus on a first direction relative to the user;
while maintaining the focus on the first direction, using scanning microphones to scan the environment by forming a scanning audio beam displaced from the first direction to capture second sound waves that indicate a first changed location of the sound source relative to the user during a second time period; and
forming the primary audio beam to focus on a second direction of the first changed location.

17. The non-transitory computer-readable storage medium of claim 16, wherein the operations further comprise:
determining movement features associated with the sound source relocating from the first changed location to at least one additional changed location;
employing an artificial intelligence (AI) model trained on known movement features, prior location changes, and sound source information, wherein the AI model uses the movement features and sound source identifying information as input and outputs a predicted changed location of the sound source for a predicted time; and
based at least in part, on the predicted changed location, forming the primary audio beam in a third direction during the predicted time.

18. The non-transitory computer-readable storage medium of claim 16, wherein forming the primary audio beam in the second direction includes expanding a width of the primary audio beam to cover a scanning area of the scanning audio beam in the second direction.

19. The non-transitory computer-readable storage medium of claim 16, wherein scanning of the environment includes repeatedly:
expanding a width of the scanning audio beam from an original width consistent with the width and direction of the primary audio beam, to cover a scanning focus area; and
returning to the original width and direction if the second sound waves are undetected.

20. The non-transitory computer-readable storage medium of claim 16, wherein the operations further comprise:
analyzing the second sound waves to detect a degradation pattern between scanning microphones of a first hearing unit at a first user ear and a second hearing unit at a second user ear to determine the second direction.
